(19) United States
(12) Patent Application Publication
(10) Pub. No.: US 2026/0245377 A1
(43) Pub. Date: Aug. 20, 2026

(54) IMAGE RECOGNITION MODEL MANAGEMENT DEVICE AND IMAGE RECOGNITION MODEL MANAGEMENT SYSTEM

(71) Applicant: Astemo, Ltd., Chiyoda-ku, Tokyo (JP)

(72) Inventors: Yusuke NOMA, Hitachinaka-shi, Ibaraki (JP); Tatsuhiko MONJI, Hitachinaka-shi, Ibaraki (JP); Makoto HOSAKA, Hitachinaka-shi, Ibaraki (JP); Hikari MIKAMI, Hitachinaka-shi, Ibaraki (JP)

(73) Assignee: Astemo, Ltd., Chiyoda-ku, Tokyo (JP)

(21) Appl. No.: 19/160,925

(22) PCT Filed: Jun. 9, 2023
(86) PCT No.: PCT/JP2023/021444

§ 371 Date: Aug. 29, 2025

(51) Int. Cl. G06V 20/56

(52) U.S. Cl. CPC G06V 20/588

(57) ABSTRACT

An object of the present invention is to provide an image recognition model management device and an image recognition model management system that are capable of selecting an image recognition model from among a plurality of image recognition models according to an external environment that is a surrounding environment of a vehicle and transferring the image recognition model to the external environment recognition device even in a case where communication with a management server is not possible in order to solve the above problems. In order to achieve the above object, for example, the present invention is an image recognition model management device that transfers an image recognition model transmitted from a management server to an external environment recognition device, the image recognition model management device including: a storage unit that stores a preset first image recognition model and a second image recognition model transmitted from the management server at a predetermined frequency or higher; and a model processing unit that selects the first image recognition model or the second image recognition model and transfers the selected first image recognition model or the selected second image recognition model to the external environment recognition device, in which the model processing unit switches the image recognition model to be transferred to the external environment recognition device based on external environment recognition data indicating an image recognition of the external environment recognition device.

### TECHNICAL FIELD

The present invention relates to an image recognition model management device and an image recognition model management system.

### BACKGROUND ART

Technology development has been advanced to implement a driving assistance system and an automatic driving system of an automobile, and an external environment recognition device mounted on a mobile body such as a vehicle recognizes a stationary object, a moving object, a road sign, a white line, and the like existing around the own vehicle. However, it is known that recognition accuracy is deteriorated due to an external environment.

To cope with such a problem, for example, a technology described in PTL 1 has been proposed. PTL 1 describes in paragraph 0011 that “the server 200 is a cloud server for providing a cloud service to a terminal, and in the present embodiment, a recognition model suitable for recognizing the surrounding environment of the mobile body Ve is selected from among a plurality of recognition models stored in the cloud 201 and supplied to the mobile body Ve. The mobile body Ve performs object recognition for the surrounding environment by using the recognition model supplied from the server 200, and executes advanced driver assistance systems (ADAS) or automated driving (AD) functions”.

### CITATION LIST

### Patent Literature

PTL 1: JP 2022-176816 A

### SUMMARY OF INVENTION

### Technical Problem

However, in the driving assistance system described in PTL 1, in a case where the mobile body Ve cannot communicate with the server 200 after the recognition model is supplied from the server 200, a new recognition model is not supplied from the server 200 even if the surrounding environment of the mobile body Ve changes. Therefore, in this case, there is a problem that the mobile body Ve uses a recognition model that is not suitable for the surrounding environment.

Therefore, an object of the present invention is to provide an image recognition model management device and an image recognition model management system that are capable of selecting an image recognition model from among a plurality of image recognition models according to an external environment that is a surrounding environment of a vehicle and transferring the image recognition model to the external environment recognition device even in a case where communication with a management server is not possible in order to solve the above problems.

### Solution to Problem

In order to achieve the above object, for example, an image recognition model management device of the present invention is an image recognition model management device that transfers an image recognition model transmitted from a management server to an external environment recognition device, the image recognition model management device including: a storage unit that stores a preset first image recognition model and a second image recognition model transmitted from the management server at a predetermined frequency or higher; and a model processing unit that selects the first image recognition model or the second image recognition model and transfers the selected first image recognition model or the selected second image recognition model to the external environment recognition device, in which the model processing unit switches the image recognition model to be transferred to the external environment recognition device based on external environment recognition data indicating an image recognition result of the external environment recognition device.

Further, an image recognition model management system of the present invention is, for example, an image recognition model management system including: a management server that transmits an image recognition model corresponding to an external environment of a vehicle; and an image recognition model management device that transfers the image recognition model transmitted from the management server to an external environment recognition device, in which the management server includes: a model database in which the image recognition model for each piece of external environment information of the vehicle is stored; an external environment analysis unit that generates the external environment information of the vehicle based on current location information of the vehicle; a model extraction unit that extracts, from the model database, the image recognition model corresponding to the external environment information generated based on the current location information; and a transmission unit that transmits the extracted image recognition model to the image recognition model management device, the image recognition model management device includes: a storage unit that stores a preset first image recognition model and a second image recognition model transmitted from the management server at a predetermined frequency or higher; and a model processing unit that selects the first image recognition model or the second image recognition model and transfers the selected first image recognition model or the selected second image recognition model to the external environment recognition device, and the model processing unit switches the image recognition model to be transferred to the external environment recognition device based on external environment recognition data indicating an image recognition result of the external environment recognition device.

### Advantageous Effects of Invention

According to the present invention, it is possible to provide an image recognition model management device and an image recognition model management system that are capable of selecting an image recognition model from among a plurality of image recognition models according to an external environment of a vehicle and transferring the image recognition model to the external environment recognition device even in a case where communication with a management server is not possible. Problems, configurations, and effects other than those described above will be clarified by the following description of embodiments.

### BRIEF DESCRIPTION OF DRAWINGS

FIG. 1 is a diagram illustrating an example of an overall configuration of an image recognition model management system according to a first embodiment.

FIG. 2 illustrates an example of a flowchart of processing performed by the image recognition model management system.

FIG. 3 is a diagram illustrating an example of a flowchart of image recognition model selection processing.

FIG. 4 is a diagram illustrating extraction of a frequent model.

FIG. 5 is a diagram illustrating an example of a flowchart of evaluation processing for a used image recognition model.

FIG. 6 is a diagram illustrating an example of an external environment situation with a high recognition rate.

FIG. 7 is a diagram illustrating an example of an external environment situation with a low recognition rate.

FIG. 8A is a table illustrating an example of classification of weather.

FIG. 8B is a table illustrating an example of classification of traveling time zones.

FIG. 8C is a table illustrating an example of classification of road types.

FIG. 9 illustrates examples of an external environment situation pattern.

FIG. 10 is a diagram illustrating an example of an overall configuration of an image recognition model management system according to a second embodiment.

FIG. 11 is a table illustrating an example of evaluation data.

### DESCRIPTION OF EMBODIMENTS

Hereinafter, embodiments of the present invention will be described with reference to the drawings.

### First Embodiment

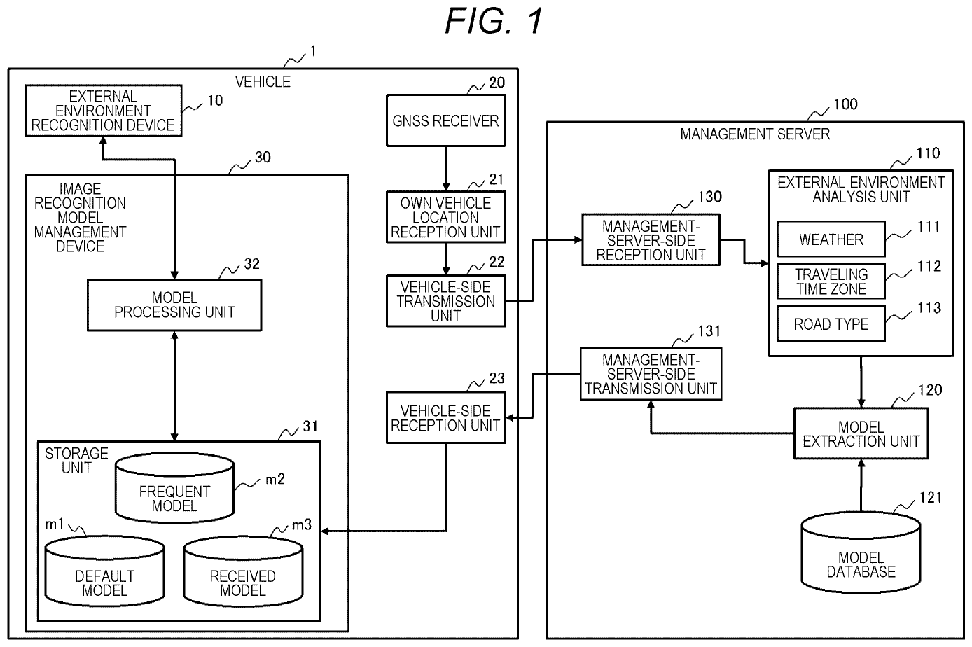

FIG. 1 is a diagram illustrating an example of an overall configuration of an image recognition model management system according to a first embodiment. The image recognition model management system includes a vehicle 1 and a management server 100.

### Management Server 100

The management server 100 is a device that determines whether or not it is necessary to switch an image recognition model used by an external environment recognition device 10 that performs image recognition based on current location information of the vehicle 1, and transmits the image recognition model to the vehicle in a case where it is determined that it is necessary to switch to the image recognition model held by the management server 100. That is, the management server 100 is a device that transmits the image recognition model corresponding to an external environment of the vehicle to the image recognition model management device. Specifically, the management server 100 includes an external environment analysis unit 110, a model extraction unit 120, a model database 121, a management-server-side reception unit 130, and a management-server-side transmission unit 131.

### Management-Server-Side Reception Unit 130

The management-server-side reception unit 130 acquires the current location information of the vehicle to which the image recognition model is to be transmitted. The current location information includes a current time in addition to a current location of the vehicle 1.

### External Environment Analysis Unit 110

The external environment analysis unit 110 collects weather information by using, for example, a public communication network such as the Internet, and generates weather information 111 (sunny, cloudy, rainy, snowy, thunderstorm, or the like) at the current location of the vehicle 1. The external environment analysis unit 110 may include communication networks other than a wide area network (WAN) and a wireless communication network such as a telephone communication network as means for collecting the weather information 111.

The external environment analysis unit 110 generates, as the traveling time zone information 112, a traveling time zone including the current time among a plurality of preset traveling time zones.

The external environment analysis unit 110 generates road type information 113 around the current location of the vehicle 1 based on map information and the like and the current location reported from the vehicle. The map information may be held in advance in a nonvolatile storage area by the management server 100, or may be acquired from the public communication network such as the Internet.

Then, the external environment analysis unit 110 transmits the generated weather information 111, traveling time zone information 112, and road type information 113 to the model extraction unit 120. The weather information 111, the traveling time zone information 112, and the road type information 113 are examples of external environment information of the vehicle 1, and the external environment information is not limited thereto.

### Model Extraction Unit 120

The model extraction unit 120 extracts the image recognition model suitable for the external environment of the current location of the vehicle 1 from the model database 121 based on the weather information 111, the traveling time zone information 112, and the road type information 113 transmitted by the external environment analysis unit 110.

### Model Database 121

The model database 121 stores a plurality of image recognition models for recognizing a surrounding environment of the current location. The stored image recognition models are a group of image recognition models trained in accordance with the weather, the traveling time zone, and the road type.

### Management-Server-Side Transmission Unit 131

The management-server-side transmission unit 131 transmits the image recognition model extracted by the model extraction unit 120 to the vehicle 1. At this time, the weather information 111, the traveling time zone information 112, and the road type information 113 used for extracting the image recognition model are transmitted in association with the image recognition model.

When the management server 100 transmits the image recognition model corresponding to the external environment information such as the weather information 111, the traveling time zone information 112, and the road type information 113, the external environment recognition device 10 can perform image recognition using the image recognition model suitable for weather, daytime and nighttime environments around the vehicle, a traveling environment, and the like.

### Vehicle 1

The vehicle 1 includes the external environment recognition device 10, a global navigation satellite system (GNSS) receiver 20, an own vehicle location reception unit 21, a vehicle-side transmission unit 22, a vehicle-side reception unit 23, and an image recognition model management device 30.

### External Environment Recognition Device 10

The external environment recognition device 10 performs image recognition on an external environment observation result of a camera sensor using an imaging element mounted on the vehicle 1 by using the image recognition model, and generates external environment recognition data of a moving object (pedestrian, bicycle, motorcycle, four-wheeled automobile, bus, truck, or the like) and a road structure (pylon, construction signboard, road sign, road marking, traffic light, or the like) that exist around the vehicle 1, a road situation (road width, road surface condition, or the like), and the like. Then, the external environment recognition device 10 transmits the external environment recognition data to a model processing unit 32 of the image recognition model management device 30.

### GNSS Receiver 20

The GNSS receiver 20 receives a navigation signal transmitted from a positioning satellite included in a GNSS. The GNSS receiver 20 generates observation data based on the navigation signal and a carrier wave of the signal. The GNSS receiver 20 sequentially outputs the observation data to the own vehicle location reception unit 21.

### Own Vehicle Location Reception Unit 21 and Vehicle-Side Transmission Unit 22

The own vehicle location reception unit 21 generates the current location information including the current location and the current time based on the observation data output from the GNSS receiver 20, and sequentially outputs the current location information of the vehicle 1 to the management server 100 via the vehicle-side transmission unit 22. Since the output of the current location information of the vehicle 1 to the management server 100 is related to a transmission timing of the image recognition model, an update frequency of the image recognition model may be increased by shortening a cycle of the output of the current location information, or the update frequency of the image recognition model may be decreased by extending the cycle.

### Image Recognition Model Management Device 30

The image recognition model management device 30 includes a microcomputer. The microcomputer is a processor (for example, a central processing unit (CPU)) that executes a program stored in a storage device. The microcomputer executes a predetermined program to operate as functional units that provide various functions. The storage device includes a nonvolatile storage area and a volatile storage area. The nonvolatile storage area includes a program area for storing the program to be executed by the microcomputer and a data area for temporarily storing data to be used when the microcomputer executes the program. The volatile storage area stores data to be used when the microcomputer executes the program. A communication interface is connected to another electronic control device via a network such as a controller area network (CAN) or Ethernet. The image recognition model management device 30 of the present embodiment includes a storage unit 31 (for example, the above-described storage device) and the model processing unit 32 (for example, the above-described processor).

### Storage Unit 31

The storage unit 31 stores a default model m1 (first image recognition model), a frequent model m2 (second image recognition model), and a received model m3 (third image recognition model).

The default model m1 is an image recognition model set in advance in the storage unit 31, and is stored in the nonvolatile storage area as a basic image recognition model used by the external environment recognition device 10. The image recognition model is used immediately after an ignition switch is turned on.

The received model m3 is an image recognition model received by the vehicle-side reception unit 23 from the management server 100. The vehicle-side reception unit 23 stores, as the received model m3, the received image recognition model in the storage unit 31. At this time, the weather information 111, the traveling time zone information 112, and the road type information 113 associated with the received model m3 are also stored in the storage unit 31. Since transmission from the management server 100 is performed when wireless communication is established, the received model m3 and the weather information 111, the traveling time zone information 112, and the road type information 113 that are associated with the received model m3 are stored in the volatile storage area in consideration of a possibility that the received model m3 is an image recognition model that is not suitable for the current external environment in a situation where wireless communication cannot be established.

The frequent model m2 is the received model m3 for the traveling time zone or road type in or for which the image recognition model is frequently transmitted from the management server 100, and is stored in the nonvolatile storage area. Details of the determination of the frequency are described below. The frequent model m2 stored in the nonvolatile storage area can be deleted from a user side. In addition, the frequent model m2 may be stored as a preset memory and selected from the user side.

In the present embodiment, as illustrated in FIG. 1, an example in which one default model m1, one frequent model m2, and one received model m3 are stored in the storage unit 31 is described, but the present invention is not limited thereto. For example, a plurality of default models m1, a plurality of frequent models m2, or a plurality of received models m3 may be stored. In a case where the image recognition model is not transmitted from the management server 100, the received model m3 is not stored in the storage unit 31.

### Model Processing Unit 32

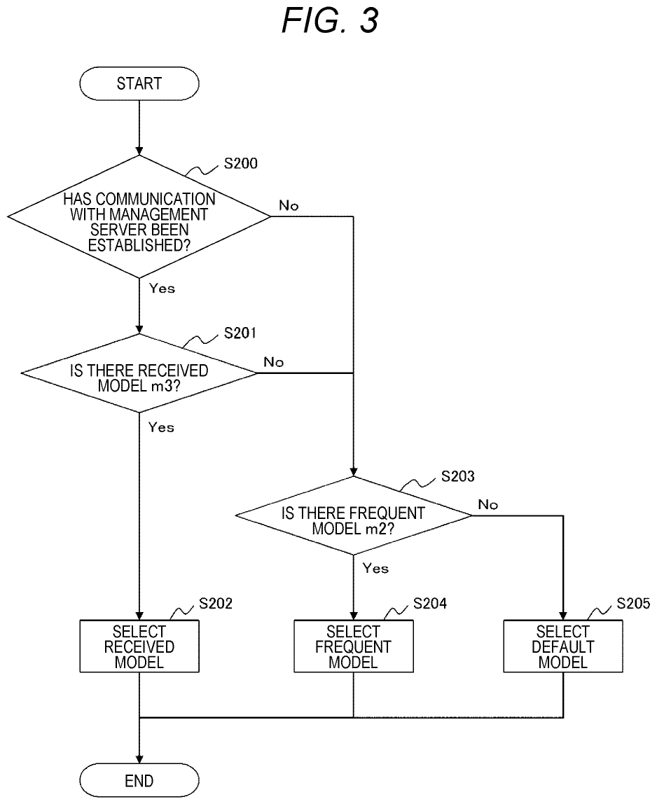

The model processing unit 32 selects the image recognition model to be transferred to the external environment recognition device 10 from among the image recognition models stored in the storage unit 31, and transfers the selected image recognition model to the external environment recognition device 10. In addition, the received model m3 for the traveling time zone or road type in or for which the image recognition model is frequently transmitted from the management server 100 is stored in the storage unit 31 as the frequent model m2. Furthermore, the image recognition model used by the external environment recognition device 10 is evaluated based on the external environment recognition data transmitted from the external environment recognition device 10. Specific processing performed by the model processing unit 32 is described below with reference to FIGS. 3 to 5.

### Flowchart

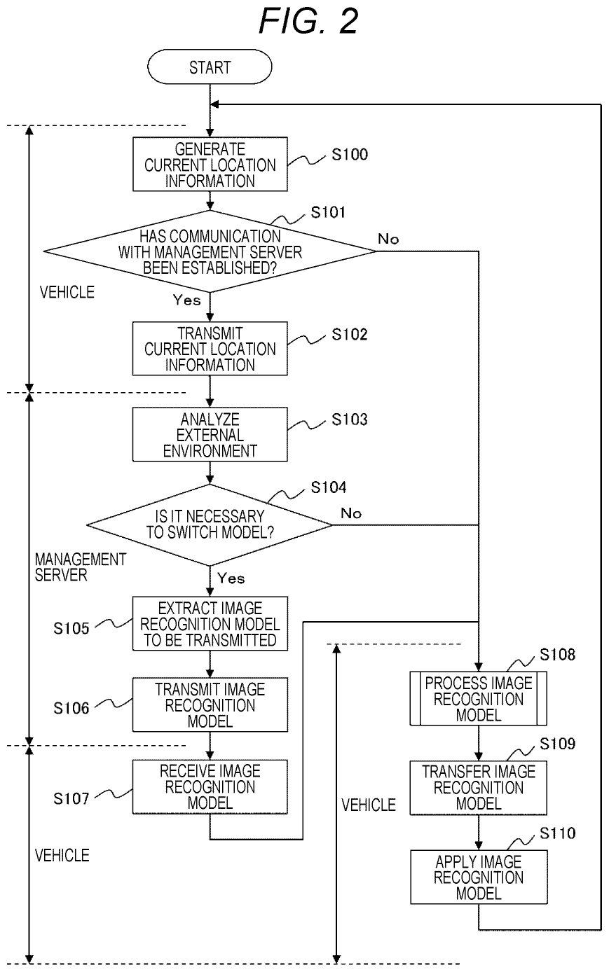

FIG. 2 illustrates an example of a flowchart of processing performed by the image recognition model management system. When the ignition switch is turned on, the processing proceeds to step S100.

In step S100, the own vehicle location reception unit 21 of the vehicle 1 generates the current location information based on the observation data of the GNSS receiver 20.

In step S101, the vehicle 1 determines whether or not wireless communication with the management server 100 has been established. The determination of establishment of the wireless communication is performed, for example, by transmitting a communication request from the vehicle 1 to the management server 100 and confirming a response from the management server 100. In a case where the wireless communication has been established, the processing proceeds to step S102. In a case where the wireless communication has not been established, the processing proceeds to step S108.

In step S102, the vehicle 1 transmits the current location information generated by the own vehicle location reception unit 21 to the management server 100.

In step S103, the external environment analysis unit 110 of the management server 100 generates the weather information 111, the traveling time zone information 112, and the road type information 113 based on the current location information received from the vehicle 1.

In step S104, the model extraction unit 120 of the management server 100 determines whether or not it is necessary to switch the image recognition model. In a case where it is determined that it is necessary to switch the image recognition model, the processing proceeds to step S105, and in a case where it is determined that it is not necessary to switch the image recognition model, the processing proceeds to step S108.

In step S105, the model extraction unit 120 of the management server 100 extracts the image recognition model to be transmitted to the vehicle 1 from the model database 121 based on the weather information 111, the traveling time zone information 112, and the road type information 113.

In step S106, the management-server-side transmission unit 131 of the management server 100 transmits the image recognition model extracted in step S105 to the vehicle 1.

In step S107, the vehicle 1 receives the image recognition model transmitted from the management server 100.

In step S108, the model processing unit 32 of the vehicle 1 selects the image recognition model to be transferred to the external environment recognition device 10 from among the image recognition models stored in the storage unit 31. In addition, the model processing unit 32 stores, as the frequent model m2, the received model m3 for the traveling time zone or road type in or for which the image recognition model is frequently transmitted from the management server 100 in the storage unit 31. Furthermore, the model processing unit 32 evaluates the image recognition model used by the external environment recognition device 10 based on the external environment recognition data transmitted from the external environment recognition device 10.

In step S109, the model processing unit 32 of the vehicle 1 transfers the image recognition model extracted in step S108 to the external environment recognition device 10.

In step S110, the external environment recognition device 10 of the vehicle 1 applies the image recognition model transferred in step S109.

### Selection of Image Recognition Model to be Transferred

Here, the selection of the image recognition model in step S108 will be described with reference to FIG. 3. FIG. 3 is a diagram illustrating an example of a flowchart of image recognition model selection processing.

In step S200, the vehicle 1 determines whether or not wireless communication with the management server 100 has been established. The determination of the establishment of the wireless communication is similar to step S101 in FIG. 2. In a case where the wireless communication has been established, the processing proceeds to step S201, and in a case where the wireless communication has not been established, the processing proceeds to step S203.

In step S201, the model processing unit 32 confirms whether or not the image recognition model has been transmitted from the management server 100 to the vehicle 1. Specifically, the model processing unit 32 confirms whether or not the received model m3 is stored in the storage unit 31. In a case where the received model m3 is stored in the storage unit 31, it is considered that the image recognition model suitable for the external environment is stored, and thus, the processing proceeds to step S202. In a case where the received model m3 is not stored in the storage unit 31, it is considered that the image recognition model suitable for the external environment is not stored, and thus, the processing proceeds to step S203.

In step S202, the model processing unit 32 selects the received model m3 as the image recognition model to be transferred to the external environment recognition device 10. In a case where the received model m3 has already been selected, the received model m3 continues to be selected. In this case, the image recognition model is not switched.

In step S203, the model processing unit 32 confirms whether or not the frequent model m2 is stored in the storage unit 31. In a case where the frequent model m2 is stored, the processing proceeds to step S204, and in a case where the frequent model m2 is not stored, the processing proceeds to step S205.

In step S204, the model processing unit 32 selects the frequent model m2 as the image recognition model to be transferred to the external environment recognition device 10. In a case where the frequent model m2 has already been selected, the frequent model m2 continues to be selected. In this case, the image recognition model is not switched.

In step S205, the model processing unit 32 selects the default model m1 as the image recognition model to be transferred to the external environment recognition device 10. In a case where the default model m1 has already been selected, the default model m1 continues to be selected. In this case, the image recognition model is not switched.

### Extraction of Frequent Model

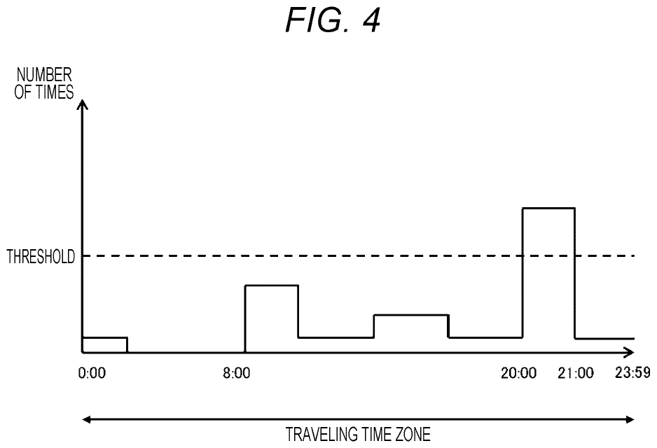

The extraction of the frequent model performed by the model processing unit 32 will be described with reference to FIG. 4. FIG. 4 illustrates an example of a case where the frequent model m2 is extracted focusing on the traveling time zone. In FIG. 4, a horizontal axis represents a traveling time zone (0:00 to 23:59), and a vertical axis represents the number of times of transmission in the traveling time zone transmitted from the management server 100 in association with the image recognition model. In FIG. 4, a width of the traveling time zone is one hour. In the example of FIG. 4, the number of times of transmission in a traveling time zone from 20:00 to 21:00 is large and exceeds a threshold (for example, ten times) of the number of times of transmission. That is, the number of times of transmission of the image recognition model associated with the traveling time zone from 20:00 to 21:00 is large and exceeds the threshold (for example, ten times) of the number of times of transmission. Therefore, the received model m3 associated with the traveling time zone from 20:00 to 21:00 is stored in the storage unit 31 as the frequent model m2. In a case where there are a plurality of traveling time zones in which the number of times of transmission exceeds the threshold and there are also a plurality of image recognition models, the plurality of image recognition models may be stored in the storage unit 31 as the frequent models m2. Alternatively, only the received model m3 associated with the traveling time zone with the largest number of times of transmission may be stored in the storage unit 31 as the frequent model m2. The same applies to the road type instead of the traveling time zone. The example of FIG. 4 focuses on the number of times of transmission, but the focus may be placed on a transmission ratio (the number of times of transmission with respect to the total number of times of transmission, and a threshold in this case is, for example, 50%).

### Evaluation of Image Recognition Model Used by External Environment Recognition Device 10

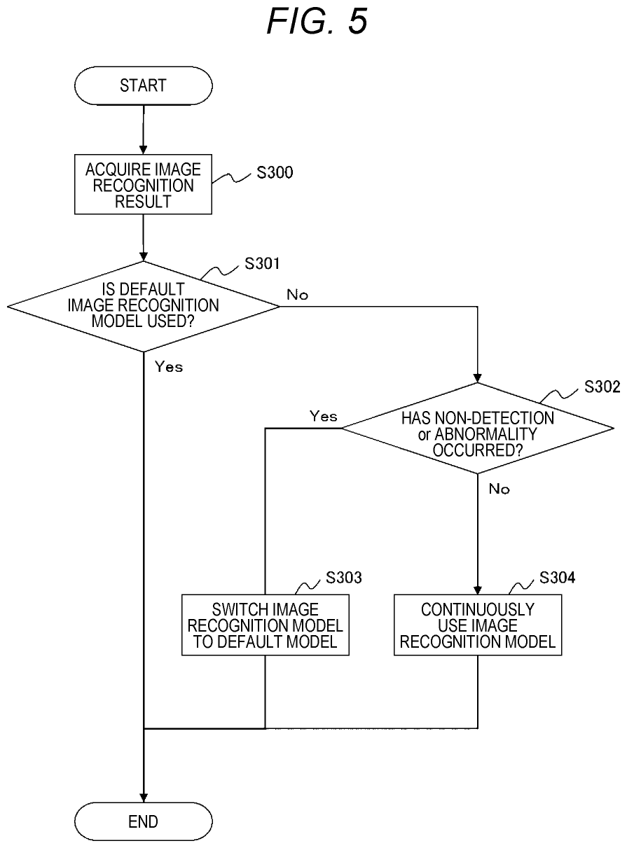

The model processing unit 32 evaluates the image recognition model used by the external environment recognition device 10 based on the external environment recognition data transmitted from the external environment recognition device 10. FIG. 5 is a diagram illustrating an example of a flowchart of evaluation processing for the image recognition model used by the external environment recognition device 10. The image recognition model used by the external environment recognition device 10 is transferred by the model processing unit 32 to the external environment recognition device 10. The flowchart illustrated in FIG. 5 will be described as being performed in step S108 in FIG. 2, but the present invention is not limited thereto. For example, as a step different from step S108, a step of evaluating the used image recognition model and instructing switching of the image recognition model based on the evaluation result may be included.

In step S300, the model processing unit 32 acquires the external environment recognition data from the external environment recognition device 10. The external environment recognition data is an image recognition result of the external environment recognition device 10, and includes information indicating whether or not an object has been detected, object type information regarding a detected object, an object recognition rate, and the like. Although the model processing unit 32 acquires the external environment recognition data in real time, the external environment recognition data of a predetermined period may be collectively acquired at certain intervals. In a case where the external environment recognition data cannot be acquired from the external environment recognition device 10 due to the external environment recognition device 10 not performing external environment recognition or the like at a time point at which the flowchart illustrated in FIG. 5 is to be performed, the flowchart illustrated in FIG. 5 is not performed.

In step S301, if the image recognition model used by the external environment recognition device 10 is the default model m1, the model processing unit 32 ends the flowchart of FIG. 5 without evaluating the image recognition model. In a case where the image recognition model used by the external environment recognition device 10 is the frequent model m2 or the received model m3, the processing proceeds to step S302.

In step S302, the model processing unit 32 evaluates the image recognition model used by the external environment recognition device 10 based on the external environment recognition data, and determines whether or not to switch the image recognition model used by the external environment recognition device 10 to the default model m1 based on the evaluation result. Specifically, based on the external environment recognition data, in a case where the number of alternations between detection and non-detection of an object is a predetermined value (for example, five times) or more, or in a case where the number of changes in an object type recognition result for the same object, such as a case where an object recognized as a standard-sized vehicle changes to a motorcycle, a bus, a truck, or the like, is a predetermined value (for example, five times) or more, the processing proceeds to step S303, and otherwise, the processing proceeds to step S304.

In step S303, since it is determined that accuracy of the frequent model m2 or the received model m3 is poor, the used image recognition model is switched to the default model m1.

In step S304, since it is determined that there is no problem in the accuracy of the frequent model m2 or the received model m3, the used image recognition model is continuously used.

### Specific Situation

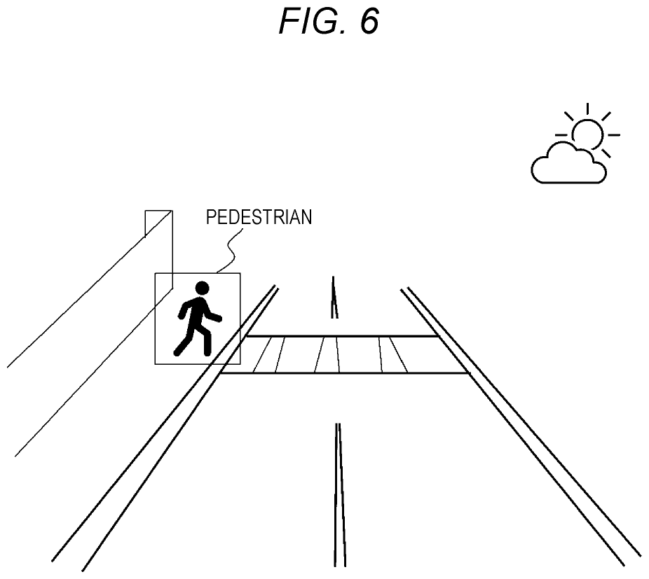

FIG. 6 illustrates an example of a situation with a high recognition rate. The situation is a situation in which the weather is sunny, the traveling time zone is daytime (8:00 to 16:00), the road type is a general road (city street) with few obstacles, and a pedestrian who is about to cross a crosswalk in such an external environment is detected. Since the situation illustrated in the example is not an external environment that is difficult to recognize, it is possible to perform highly accurate recognition with the basic recognition model, and it is not necessary to transmit the image recognition model from the management server 100.

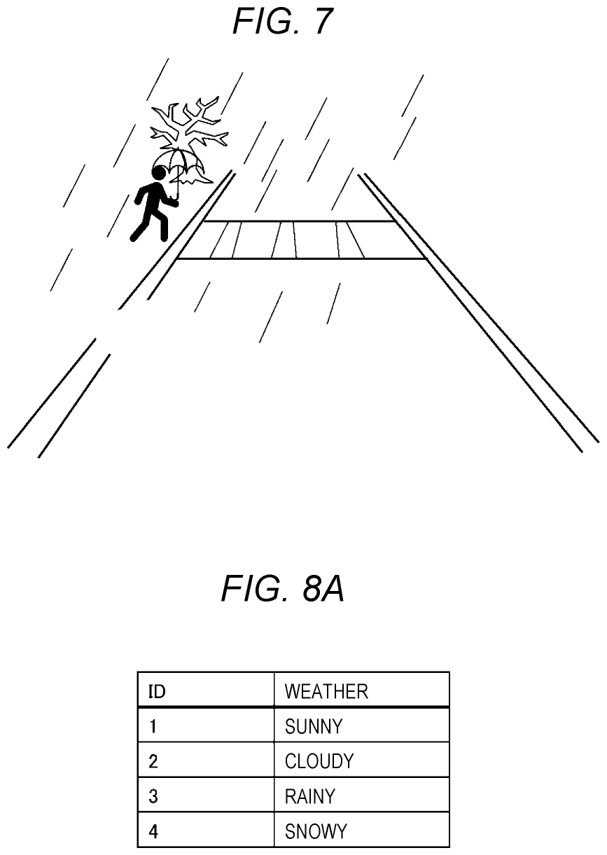

FIG. 7 illustrates an example of a situation with a low recognition rate. The situation is a situation in which the weather is rainy, the traveling time zone is nighttime (19:00 to 8:00), the road type is a general road (residential road) with a puddle, and there is a pedestrian who is about to cross a crosswalk in such an external environment. In an environment where the road is narrow and it is raining, there is a possibility that recognition accuracy for the pedestrian holding an umbrella may be low in the case of using the basic recognition model. Furthermore, in a case where such a situation is additionally learned by the basic recognition model, there is a possibility that a situation with a high recognition rate is affected. Therefore, deterioration of the recognition accuracy can be reduced by applying the image recognition model transmitted from the management server 100. In addition, since supporting all the image recognition models in the vehicle 1 causes an increase in storage capacity requirements, cost, and processing load, it is possible to obtain an effect of reducing deterioration of the recognition accuracy while using a minimum number of image recognition models. However, for a sudden accident such as a sudden thunderstorm or heavy rain, falling trees or objects, or an accident occurring in front of the vehicle, transmission of the image recognition model from the management server 100 may not be performed in time. Therefore, deterioration of the object recognition accuracy is reduced as much as possible by evaluating the used image recognition model. In the present invention, as the external environment of the vehicle 1 is analyzed by the management server 100 and an appropriate image recognition model is transmitted, variations in the effects of the invention can be suppressed, and the same effect can be obtained for all the vehicles. In a case where the vehicle 1 analyzes the external environment, the evaluation result may be different for each vehicle, and it is considered that the recognition accuracy may be improved in a certain vehicle, and the recognition accuracy may be deteriorated in a certain vehicle. In this regard, the management server can obtain a certain effect in all vehicles by analyzing the external environment, and it is also possible to easily change a method of the external environment analysis.

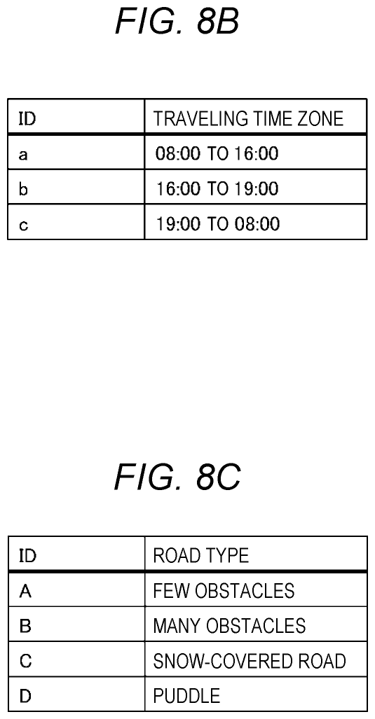

FIG. 8A is a table illustrating an example of classification of the weather. FIG. 8B is a table illustrating an example of classification of the traveling time zones. FIG. 8C is a table illustrating an example of classification of the road types. The model extraction unit 120 of the management server 100 determines the image recognition model to be transmitted to the vehicle 1 mainly based on a combination of the weather, the traveling time zone, and the road type. FIGS. 8A to 8C illustrate examples, and the number of elements to be combined may be increased, or the weather and the traveling time zone may be finely set. The classifications vary depending on the granularity of the image recognition model to be transmitted.

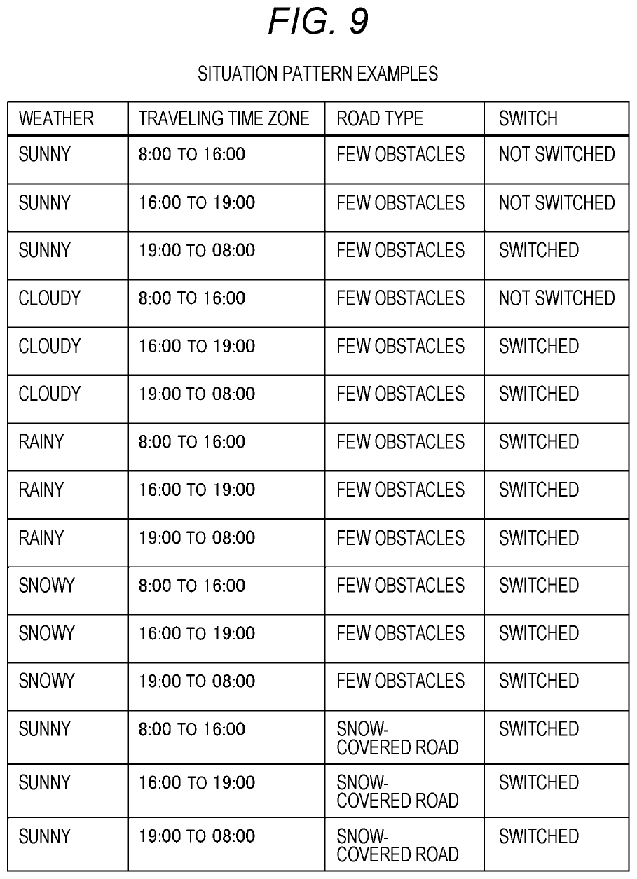

FIG. 9 is a diagram for describing determination on whether or not it is necessary to switch the image recognition model to be transmitted. In FIG. 9, each row shows a combination of the weather information 111, the traveling time zone information 112, and the road type information 113 output by the external environment analysis unit 110 of the management server 100. Then, in the fourth column from the left, necessity of switching of the image recognition model to be transmitted to the vehicle 1 is described. Since the weather and the traveling time zone greatly affects the image recognition model, the image recognition model is often determined based on these two factors. In addition, a puddle due to rainfall, a change in the external environment due to snowfall, and a mountain road with a large number of steep slopes are also considered in determination of the image recognition model.

For example, in a case where the traveling time zone is from 19:00 to 8:00, the model extraction unit 120 of the management server 100 determines that it is necessary to switch the image recognition model. Furthermore, in a case where the traveling time zone is from 16:00 to 19:00, the model extraction unit 120 determines that it is not necessary to switch the image recognition model to be transmitted when the weather is sunny, and determines that it is necessary to switch the image recognition model to be transmitted when the weather is cloudy. Furthermore, in a case where the weather is rainy or snowy, the model extraction unit 120 determines that it is necessary to switch the image recognition model to be transmitted. In addition, the model extraction unit 120 also determines that it is necessary to switch the image recognition model to be transmitted when the road type is a snow-covered road. However, a method of determining whether or not to switch the image recognition model to be transmitted is not limited thereto. For example, the determination method may change depending on a season, a traveling area, or the like.

According to the present invention, it is possible to provide an image recognition model management device and an image recognition model management system that are capable of selecting an image recognition among a plurality of image recognition models according to an external environment of a vehicle and transferring the image recognition model to the external environment recognition device even in a case where communication with a management server is not possible.

In addition, as the management server analyzes the external environment and provides the recognition model, it is possible to reduce variations that occur in the evaluation by each vehicle.

### Second Embodiment

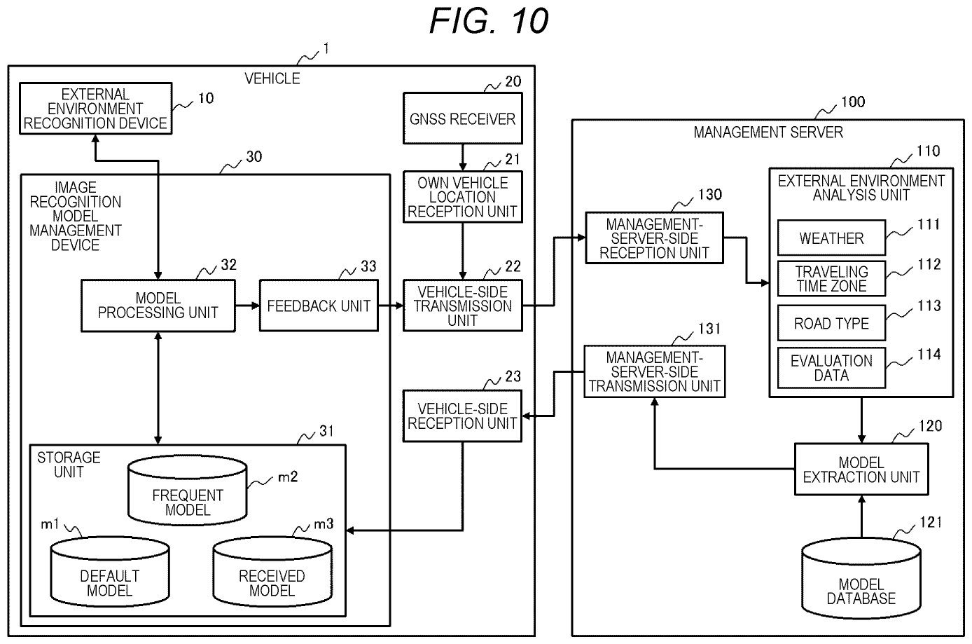

FIG. 10 is a diagram illustrating an example of an overall configuration of an image recognition model management system according to a second embodiment. The present embodiment is different from the first embodiment in that an image recognition model management device 30 includes a feedback unit 33. Hereinafter, differences from the first embodiment will be mainly described.

In the first embodiment, it is assumed that an image recognition model transmitted from a management server 100 is applied and evaluated. On the other hand, in the present embodiment, it is assumed that a result of evaluating the image recognition model transmitted from the management server 100 to a vehicle 1 is fed back to the management server 100. Therefore, in the present embodiment, it is assumed that wireless communication between the management server 100 and the vehicle 1 is established.

The feedback unit 33 generates evaluation data 114 such that an external environment analysis unit 110 of the management server 100 can perform analysis based on an evaluation result of a model processing unit 32.

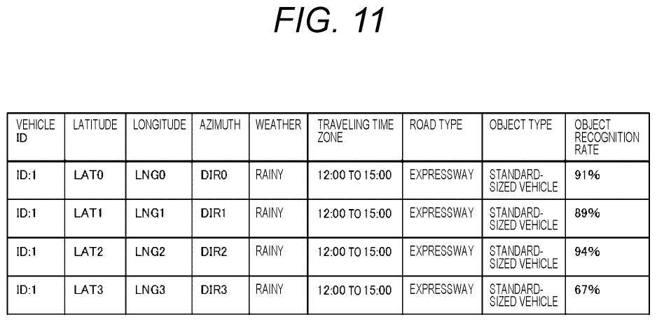

FIG. 11 is a table illustrating an example of the evaluation data. A vehicle ID is unique for each vehicle and is not duplicated. As latitude, longitude, and azimuth, information acquired from a GNSS receiver 20 of the vehicle 1 is stored. Weather, a traveling time zone, and a road type are based on information transmitted from the management server 100. As an object type and an object recognition rate, the evaluation result of the model processing unit 32 is stored. The vehicle 1 transmits information of the feedback unit 33 to the management server 100 via a vehicle-side transmission unit 22.

A management-server-side reception unit 130 of the management server 100 receives the evaluation data 114 transmitted from the vehicle. The external environment analysis unit 110 transmits the evaluation data 114 received by the management-server-side reception unit 130 to a model extraction unit 120. In a case where communication between the management server 100 and the vehicle 1 is established and the management server 100 transmits the image recognition model, as illustrated in the flowchart of FIG. 3, the model processing unit 32 selects the image recognition model (received model m3) transmitted by the management server 100, so that the external environment recognition device 10 uses the received model m3. Therefore, the evaluation data 114 in a case where communication between the management server 100 and the vehicle 1 is established and the management server 100 transmits the image recognition model represents evaluation on the image recognition model transmitted by the management server 100.

For example, in a case where the object recognition rate included in the evaluation data 114 is equal to or lower than a predetermined value, the model extraction unit 120 switches the image recognition model to be transmitted to another image recognition model and transmits the image recognition model. In addition, the model extraction unit 120 stores the evaluation data 114 in a model database 121 in association with the corresponding image recognition model. For example, in a case where both an image recognition model A and an image recognition model B stored in the model database 121 are suitable for the same weather information 111, traveling time zone information 112, and road type information 113, it is possible to select one having a higher object recognition rate or the like by using the evaluation data 114 and transmit the selected one to the vehicle 1.

Therefore, according to the present embodiment, the management server 100 can transmit the image recognition model more suitable for the external environment of the vehicle. Then, image recognition accuracy of the external environment recognition device 10 can be improved.

The present invention is not limited to the above-described embodiments, and includes various modified examples. For example, the above-described embodiments have been described in detail in order to describe the present invention in an easy-to-understand manner, and the present invention is not necessarily limited to those having all the described configurations. In addition, some or all of the above-described configurations, functions, processing units, processing means, and the like may be implemented by hardware, for example, by designing with an integrated circuit or the like. In addition, each of the above-described configurations, functions, and the like may be implemented by software by a processor interpreting and executing a program for implementing each function. Information such as a program, a table, and a file for implementing each function can be stored in a recording medium such as a memory, a hard disk, and a solid state drive (SSD), or a recording medium such as an integrated circuit (IC) card, a secure digital (SD) card, or a digital versatile disk (DVD).

### REFERENCE SIGNS LIST

1 vehicle
10 external environment recognition device
20 GNSS receiver
21 own vehicle location reception unit
22 vehicle-side transmission unit
23 vehicle-side reception unit
30 image recognition model management device
31 storage unit
32 model processing unit
33 feedback unit
m1 default model
m2 frequent model
m3 received model
100 management server
110 external environment analysis unit
111 weather information
112 traveling time zone information
113 road type information
114 evaluation data
120 model extraction unit
121 model database
130 management-server-side reception unit
131 management-server-side transmission unit

1. An image recognition model management device that transfers an image recognition model transmitted from a management server to an external environment recognition device, the image recognition model management device comprising:
a storage unit that stores a preset first image recognition model and a second image recognition model transmitted from the management server at a predetermined frequency or higher; and
a model processing unit that selects the first image recognition model or the second image recognition model and transfers the selected first image recognition model or the selected second image recognition model to the external environment recognition device,
wherein the model processing unit switches the image recognition model to be transferred to the external environment recognition device based on external environment recognition data indicating an image recognition result of the external environment recognition device.

2. The image recognition model management device according to claim 1, wherein
the model processing unit acquires the external environment recognition data from the external environment recognition device using the second image recognition model, evaluates the second image recognition model based on the external environment recognition data, and switches the image recognition model to be transferred to the external environment recognition device to the first image recognition model based on an evaluation result.

3. The image recognition model management device according to claim 2, wherein
the model processing unit switches image recognition model to be transferred to the external environment recognition device to the first image recognition model in a case where it is determined that the number of alternations between detection and non-detection of an object is a predetermined value or more or in a case where it is determined that the number of changes in an object type recognition result for the same object is a predetermined value or more, based on the external environment recognition data.

4. The image recognition model management device according to claim 1, comprising a vehicle-side reception unit that receives, from the management server, road type information at a current location of a vehicle, traveling time zone information of the vehicle, and the image recognition model suitable for the road type information and the traveling time zone information,
wherein the model processing unit measures the number of times of transmission from the management server for each piece of road type information or for each piece of traveling time zone information, and stores the image recognition model suitable for the road type information or the traveling time zone information with a largest number of times of transmission in the storage unit as the second image recognition model.

5. The image recognition model management device according to claim 1, wherein
the storage unit stores the image recognition model transmitted from the management server as a third image recognition model, and
in a case where the third image recognition model is stored in the storage unit, the model processing unit selects the third image recognition model and transfers the third image recognition model to the external environment recognition device.

6. The image recognition model management device according to claim 5, wherein
the model processing unit acquires the external environment recognition data from the external environment recognition device using the second image recognition model or the third image recognition model, evaluates the image recognition model used by the external environment recognition device based on the external environment recognition data, and switches the image recognition model to be transferred to the external environment recognition device to the first image recognition model based on an evaluation result.

7. An image recognition model management system comprising:
a management server that transmits an image recognition model corresponding to an external environment of a vehicle; and
an image recognition model management device that transfers the image recognition model transmitted from the management server to an external environment recognition device, wherein
the management server includes:
a model database in which the image recognition model for each piece of external environment information of the vehicle is stored;
an external environment analysis unit that generates the external environment information of the vehicle based on current location information of the vehicle;
a model extraction unit that extracts, from the model database, the image recognition model corresponding to the external environment information generated based on the current location information; and
a transmission unit that transmits the extracted image recognition model to the image recognition model management device,
the image recognition model management device includes:
a storage unit that stores a preset first image recognition model and a second image recognition model transmitted from the management server at a predetermined frequency or higher; and
a model processing unit that selects the first image recognition model or the second image recognition model and transfers the selected first image recognition model or the selected second image recognition model to the external environment recognition device, and
the model processing unit switches the image recognition model to be transferred to the external environment recognition device based on external environment recognition data indicating an image recognition result of the external environment recognition device.
